(19) United States
(12) Patent Application Publication
(10) Pub. No.: US 2023/0356616 A1
(43) Pub. Date: Nov. 9, 2023

(54) SYSTEM AND METHOD FOR SMART SELECTION OF CHARGING STATION

(71) Applicant: GM GLOBAL TECHNOLOGY OPERATIONS LLC, Detroit, MI (US)

(72) Inventors: Venkata Naga Siva Vikas Vemuri, New Hudson, MI (US); Andrew J. MacDonald, Grosse Pointe Park, MI (US); Charles A. Everhart, Canton, MI (US); Omer Zerbib, Kfar Saba (IL); Vishnu Chikondla, Novi, MI (US); Rajas M. Sevekari, Macomb, MI (US)

(73) Assignee: GM GLOBAL TECHNOLOGY OPERATIONS LLC, Detroit, MI (US)

(21) Appl. No.: 17/738,355

(22) Filed: May 6, 2022

(51) Int. Cl. B60L 53/62; B60L 53/67; B60L 53/66

(52) U.S. Cl. CPC B60L 53/66; B60L 53/62; B60L 53/665; B60L 53/67; B60L 2240/547

(57) ABSTRACT

A method and system for smart selection of a charging station is contemplated. The selection may be based on a charging recommendation being generated in reply to a charging request for battery charging. The charging recommendation may identify one or more target charging stations suitable for the battery charging. The charging recommendation may include a state of health (SOH) matrix configured to report charging capabilities of the target charging stations according to vehicle and station charging metrics associated therewith.

### INTRODUCTION

The present disclosure relates to a system and method for smart selection of charging stations to be used in charging an electric vehicle.

An electric vehicle may include a battery to provide electrical energy for powering an electric motor. The capability of the electric motor may be dependent on the amount of electrical energy available from the battery such that the battery may require periodic charging at a charging station to assure a sufficient supply of electrical energy, i.e., a range of an electric vehicle may be dependent on an ability to locate charging stations along a planned route. It may be challenging to identify suitable charging stations amongst the ever-increasing quantity of available charging stations. One challenge relates to some vehicle operators lacking awareness of technical details associated with the vehicle’s battery, e.g., type of connector needed for charging, capability to support fast charging, a distance the vehicle can travel on low battery before shutdown, etc. Another challenge relates to inaccuracies in the reporting of charging capabilities for the charging stations, particularly when charging stations are self-interested, independent entities that report their own, unregulated information, e.g., charging stations may falsely advertise cost, charging time, wait time, fast charging capabilities, location, available connectors, etc.

### SUMMARY

One non-limiting aspect of the present disclosure relates to a system for smart selection of a charging station. The system may include a metrics controller configured to: receive vehicle charging metrics from a plurality of vehicles in response to the vehicles engaging a plurality of charging stations for battery charging; and receive station charging metrics from the plurality of charging stations in response to the charging stations engaging the vehicles for battery charging. The system may further include a selection controller configured to transmit a charging recommendation in reply to a target vehicle of the vehicles issuing a charging request for battery charging. The charging recommendation may identify one or more target charging stations of the charging stations suitable for the battery charging. The charging recommendation may include a state of health (SOH) matrix configured to report charging capabilities of the target charging stations according to the vehicle and station charging metrics associated therewith.

The system may include charging controllers onboard the vehicles. The charging controllers may be configured to collect the vehicle charging metrics in response to a charging system of the associated vehicle engaging one of the charging stations for battery charging.

The system may include the vehicle controllers and the charging stations collecting the vehicle and station charging metrics to represent a charging mode, a charging voltage, a cost, a time of charging, a payment mode, a time duration, and a station ID for the associated charging station.

The system may include the SOH matrix including plurality of categories, including an overall ranking, a charging station ID, a charging efficiency, a time per regular charge, a time per fast charge, an additional charge for fast charge, a wait time, a wireless payment, and a deviation from route time, and a battery efficiency.

The system may include the SOH matrix including a score within each of the categories to represent corresponding charging capabilities for each of the target charging stations.

The system may include each of the scores being coded according to one of a first coding, a second coding, a third coding, and a fourth coding. The first coding may represent the corresponding score being inoperably less than a range, the second coding may represent the corresponding score being operably less than the range, the third coding may represent the corresponding score being within the range, and the fourth coding may represent the corresponding score being greater than the range.

The system may include user experience controllers onboard the vehicles. The use experience controllers may be configured to generate the charging request in response determining a need for battery charging.

The system may include the user experience controllers being configured to interface the SOH matrix with an operator of the associated vehicle.

The system may include battery controllers onboard the vehicles configured to generate a battery report for a battery of the associated vehicle. The battery reports may be generated in response to the battery controllers testing for health of the battery.

The system may include the battery controllers are configured to encrypt being battery reports before transmission to the selection controller.

The system may include the battery controllers performing testing on the associated battery to determine a battery SOH, an average reserve range, and a warmup prediction.

The system may include the selection controller being configured to generate the battery efficiency based at least in part on the health identified in the battery reports.

One non-limiting aspect of the present disclosure relates to a method for smart selection of a charging station. The method may include receiving vehicle charging metrics from a plurality of vehicles in response to charging systems of the vehicles engaging a plurality of charging stations for battery charging. The method may further include receiving station charging metrics from the plurality of charging stations in response to engaging the vehicles for battery charging. The method may yet further include transmitting a charging recommendation in reply to a target vehicle of the vehicles issuing a charging request for battery charging where the charging recommendation identifies charging capabilities of one or more target charging stations of the charging stations according to the vehicle and station charging metrics associated therewith.

The method may include generating the charging recommendation to include a state of health (SOH) matrix, the SOH matrix configured to identify the charging capabilities of the target charging stations.

The method may include generating the SOH matrix to include a plurality of categories, the plurality of categories including an overall ranking, a charging station ID, a charging efficiency, a time per regular charge, a time per fast charge, an additional charge for fast charge, a wait time, a wireless payment, a deviation from route time, and a battery efficiency.

The method may include visually coding a score included within each of the categories according to one of a first coding, a second coding, a third coding, and a fourth coding. The first coding may represent the corresponding score being inoperably less than a range, the second coding may represent the corresponding score being operably less than the range, the third coding may represent the corresponding score being within the range, and the fourth coding may represent the corresponding score being greater than the range.

The method may include generating the vehicle charging metrics with charging controllers onboard the vehicles and generating the station charging metrics with station controls included on the charging stations.

The method may include generating the charging recommendation with a selection controller offboard of the vehicles.

One non-limiting aspect of the present disclosure relates to a system for smart selection of charging stations. The system may include a plurality of charging controllers onboard a plurality of electric vehicles to collect vehicle charging metrics in response to a charging system of the associated vehicle engaging one of a plurality of charging stations for battery charging. The system may further include a plurality of station controllers included on the charging stations to generate station charging metrics in response to engaging the vehicles for battery charging. The system may yet further include a selection controller configured to transmit a charging recommendation in reply to a target vehicle issuing a charging request for battery charging. The charging recommendation may identify one or more target charging stations of the charging stations, optionally including a state of health (SOH) matrix configured to report charging capabilities of the target charging stations according to the vehicle and station charging metrics associated therewith.

The above features and advantages, and other features and attendant advantages of this disclosure, will be readily apparent from the following detailed description of illustrative examples and modes for carrying out the present disclosure when taken in context with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 illustrates a schematic view of a system in accordance with one non-limiting aspect of the present disclosure.

FIG. 2 illustrates a schematic view of a state of health (SOH) matrix in accordance with one non-limiting aspect of the present disclosure.

FIG. 3 illustrates a flowchart of a method for smart selection of a charging station in accordance with one non-limiting aspect of the present disclosure.

The above features and advantages and other features and advantages of the present teachings are readily apparent from the following detailed description of the modes for carrying out the present teachings when taken in connection with the accompanying drawings. It should be understood that even though in the following Figures embodiments may be separately described, single features thereof may be combined to additional embodiments.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

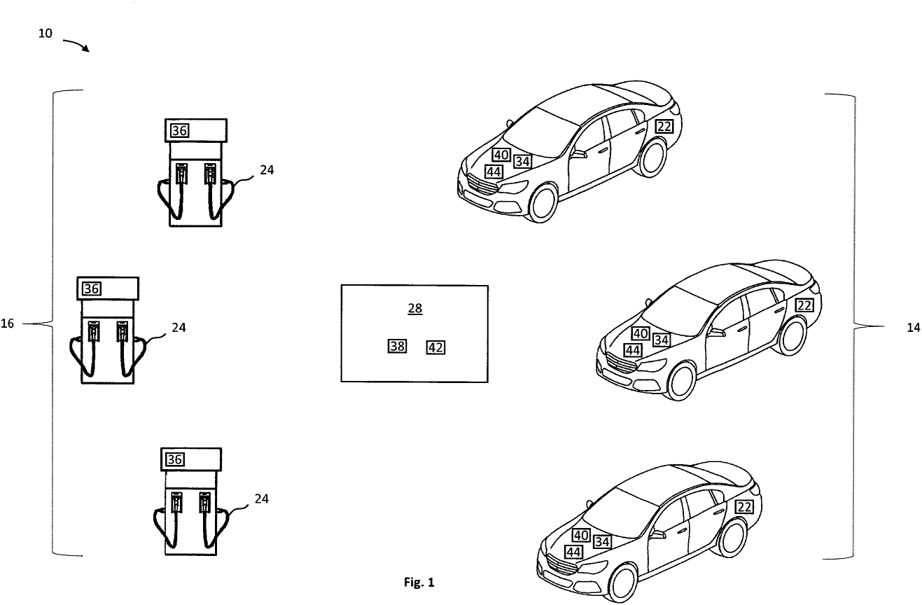

FIG. 1 illustrates a schematic view of a system 10 in accordance with one non-limiting aspect of the present disclosure. The system 10 may be configured to improve functionality of plurality of electric vehicles 14 in selecting from a plurality of charging stations 16 to facilitate battery charging. The system 10 is predominantly described with respect to the vehicles 14 being automobiles of the type having one or more batteries configured to provide electrical energy to one or more traction motors. This is done for exemplary non-limiting purposes as the present disclosure fully contemplates its use and application with other types of vehicles, including trains, planes, vessels, heavy equipment, off-road-vehicles, motorcycles, etc. The system 10 is also described with respect to the stations 16 being geographically spaced apart from each other to facilitate battery charging when vehicles 14 are traveling from one location to another. The attendant travel may warrant periodically stopping at one or more of the stations 16 to engage in a battery charging event.

A battery charging event may correspond with a battery charging system 22 on one of the vehicles 14 engaging with one of the stations 16 in a manner suitable to deliver electrical energy from one of the stations 16 to a battery, a battery pack, a capacitor, or other electrical storage medium of the vehicle 14. The stations 16 are illustrated for exemplary purposes with respect to including charging connectors 24 of the type configured to plug into receptacles or other interfaces of the battery charging system 22 as inductive charging or other types of charging may be similarly employed. The vehicles 14 may rely upon the stored electrical energy to power a traction motor or other feature of the vehicle needed to maintain desired operations, particularly those types of operations that may require periodic charging when traveling from one location to another across longer distances.

The system 10 may include a back office 28 to coordinate activities between the vehicles 14 and the charging stations 16. The system 10 may additionally include charging controllers 34 onboard the vehicles 14 and station controllers 36 at the stations 16 configured to facilitate providing the back office 28 charging metrics. The back office 28 may include a metrics controller 38 configured to receive and process the charging metrics. The charging controller 34 may be configured to interact with the battery charging system 22 to automatically collect charging metrics each time the vehicle 14 charges the battery. The station controller 36 may be similarly configured to automatically monitor charging activities from the perspective of the stations 16. The corresponding metrics, which may be referred to as vehicle charging metrics when reported with the charging controller 34 and station charging metrics when reported with the station controller 36, may represent a charging mode, a charging voltage, a cost, a time of charging, a payment mode, a time duration, and/or a station/interface ID for the associated charging event. The vehicle charging metrics and/or the station charging metrics may include additional information such that at least some of the metrics may not be identical.

The system 10 may include battery controllers 40 onboard the vehicles 14 configured to generate a battery report for the associated battery system 22. The battery reports may be shared with the metrics controller 38 and generated based on stored characteristics for the battery system 22 and/or in response to the battery controllers 40 testing for health of the battery system 22, i.e., testing individual battery cells, packs, etc. The characteristics and testing, which may include the use of test signals, may be used to determine battery metrics a vehicle owner or occupant would be unlikely to ascertain. In the event the battery characteristics and/or testing results are intended to be confidential or proprietary to the vehicle manufacture or collected through non-public diagnostical processes, for example, the battery controllers 40 may be configured to encrypt the battery reports before being locally stored and/or prior to transmission to the back office 28. The battery reports may be used to determine a type of connector needed for charging, a capability to support fast charging, a distance the vehicle can travel on low battery before shutdown, a battery SOH, an average reserve range, a warmup prediction, etc. The back office 28 may be configured to generate make recommendations based at least in part on the battery health identified in the battery reports.

The charging, station, and battery controllers 34, 36, 40 may include capabilities for communicating with the back office 28, e.g., each may rely respectively upon wireless or wired communication capabilities of the vehicle 14 and the station 16. The back office 28 may include a selection controller 42 configured to transmit a charging recommendation in reply to a charging request issued from a user experience controller 44 included onboard the vehicles 14. The charging recommendation may identify one or more target charging stations selected from the charging stations 16 that are deemed suitable to facilitate battery charging for the requesting one of the vehicles 14. The selection controller 42 may generate the recommendation in a manner that alleviates the challenge of some vehicle operators lacking awareness of technical details associated with the vehicle’s battery, e.g., type of connector needed for charging, capability to support fast charging, a distance the vehicle can travel on low battery before shutdown, etc., and that also alleviates inaccuracies in the reporting of charging capabilities for the charging stations 16.

The user experience controllers 44 may be configured to facilitate interactions with vehicle occupants through a navigation system, a telematics unit, an infotainment system, or other vehicle system and/or a mobile device of the occupant. The user experience controller 44 may be configured to generate the charging request in response to identifying a need for battery charging, such as in response to user inputs indicating a planned route, a desire for immediate charging, etc. and/or automatically in response to the battery charging system 22 identifying conditions for battery charging. The selection controller 36 may be configured to generate the recommendation in response to receipt of the charging request and/or automatically in response to monitoring global position system (GPS) coordinates of the vehicle 14 along a planned route. Each of the battery system 22, the back office 28, and the controllers 34, 36, 38, 40, 42, 44 operate according to commands, instructions, operations, etc. associated with a processor executing a corresponding plurality non-transitory instructions stored on an associated computer readable storage medium.

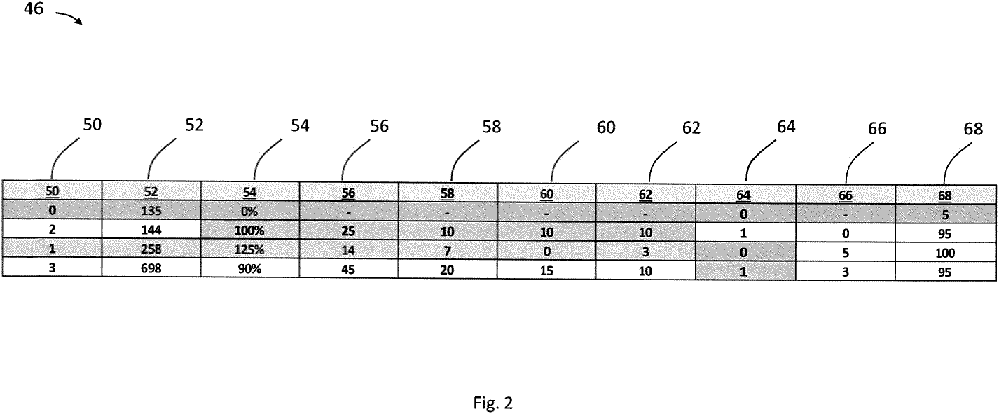

FIG. 2 illustrates a schematic view of a state of health (SOH) matrix 46 sent from the selection controller 36 in accordance with one non-limiting aspect of the present disclosure. The matrix 46 may be included as part of the recommendation for purposes of apprising the requesting one of the vehicles 14 of the stations 16 suitable for battery charging. The matrix 46 may be configured to include plurality of categories, such as an overall ranking 50, a charging station ID 52, a charging efficiency 54, a time per regular charge 56, a time per fast charge 58, an additional fee for fast charge 60, a wait time to until charging is available 62, a wireless payment availability 64, a deviation time to reach the station from a current route 66, and a battery efficiency 68. Each of the stations 16 deemed to be targets may be assigned a row of the matrix 46 with a unique identifier in the ID category 52 and a plurality of values representing a score of the corresponding station 16 for each of the respective categories 50, 52, 54, 56, 58, 60, 62, 64, 66, 68.

The scores are shown as numerical values and may include differing shades, gradients, patterns, colors, or other features to provide a visual coding mechanism for indicating relative performance of each target to their own historical average, to the average of the other listed targets, and/or to predetermined thresholds or ranges. The illustrated coding mechanism is shown for exemplary purposes as including a first coding with a horizontal pattern, a second coding with a diagonal pattern, a third coding with no pattern, and a fourth coding with a crisscross pattern. Another such coding may be a color scheme whereby the individual values may be colored, e.g., the first coding may be red, the second coding may be yellow, the third coding may be green, and the fourth coding may be black. The first coding may be used to represent the corresponding score being inoperably less than a range, i.e., that the corresponding station is unavailable or should not be used, the second coding may be used to represent the corresponding score being operably less than the range, i.e., that the corresponding station is usable but operating below the range, the third coding may be used to represent the corresponding station is operating within the range, and the fourth coding may be used to represent the corresponding station operating better or greater than the range.

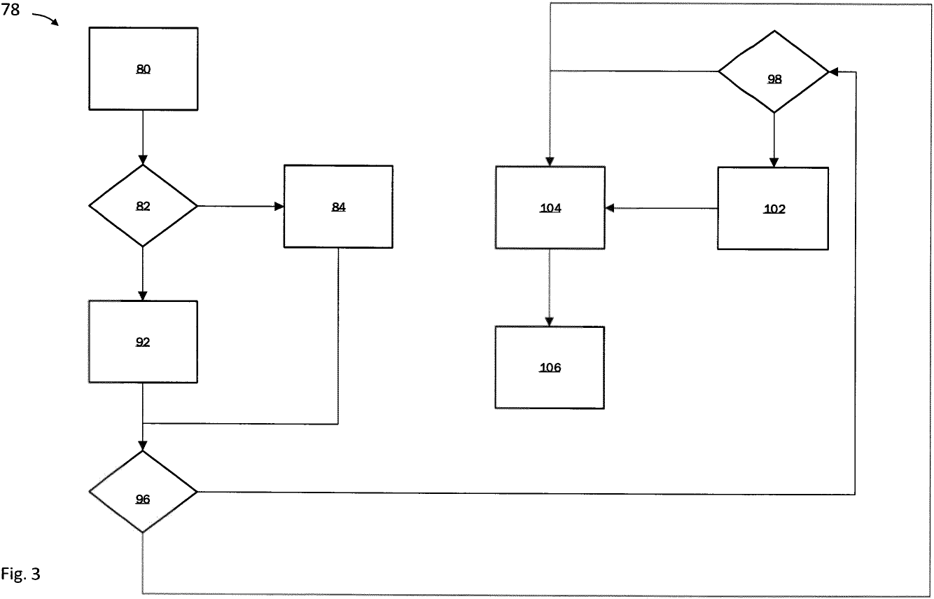

FIG. 3 illustrates a flowchart 78 of a method for smart selection of a charging station 16 in accordance with one non-limiting aspect of the present disclosure. Block 80 relates to the user experience controller 44 of the vehicle 14 in need of charging issuing the charging request to locate one or more suitable charging stations 16. Block 82 relates to the selection controller 42 determining from the charging request whether the vehicle is or intends to be stationary or traveling along a planned route. Block 82 may also include the selection controller 42 identifying characteristics and other operating constraints associated with charging the vehicles 14, such as charging requirements for the battery charging system 22. This information may be based on the battery report or information otherwise stored in a database associated with identifier for the vehicle 14 included within the charging request.

Block 84 relates to the selection controller 42 identifying potential charging stations 16 (target stations) within a predefined area around the vehicle 14 when the vehicle 14 is determined to be stationary. The predefined area may be based on a predefined distance relative to the current location and/or based on a corresponding user input to the selection controller 42. Block 84 relates to the selection controller 42 generating the SOH matrix 46 for the charging stations 16 identified in Block 84, i.e., including a row within the SOH matrix 46 for each of the target stations. The corresponding SOH matrix 46 may be populated with the last known vehicle charging metrics (current vehicle metrics) determined by the charging controllers 34 for one or more of the vehicles 14 having previously undertaken charging events at the identified charging stations 16.

In the event the vehicle 14 intends to travel along the planned route, Block 92 relates to the selection controller 42 similarly selecting the charging stations 16 to be listed in the SOH matrix 46 based on a desirable area along the route and a desirable time for charging the vehicle 14. The time and distance associated with identifying the charging stations 16 may be based on information included within the charging request, which optionally may include relying on information in the battery report generated with the battery controller 40 to facilitate identifying the time and distance when the battery charging may be needed.

Block 96 relates to the selection controller 42 comparing on a station-by-station basis the current vehicle metrics in the SOH matrix 46 relative to historical averages for the same charging stations. This process may be used to compare the current/latest vehicle charging metrics generated as a function of the last vehicle 14 to have used the corresponding charging station 16 with an historical average generated based on a greater number of vehicles 14 having also used the charging station 16. The comparison may be used to assess performance of the target charging station 16 relative to historical performance, such as to determine whether the target charging stations 16 are performing within, above, or below an average or historical range of performance. The ability to assess the performance of the targeted charging stations 16 may be beneficial in improving the operation of the user experience controller 44, as described below in more detail, to facilitate directing vehicle 14 and/or the operator to a desired one of the targets.

The comparison may result in identifying each of the target charging station 16 operating above or below an historical average such that the charging stations 16 on a score-by-score basis, i.e., each score within each category 50, 52, 54, 56, 58, 60, 62, 64, 66, 68 of the SOH matrix 46, may be individually assessed and subsequently processed in accordance with the methodology contemplated herein. The scores in the SOH metrics matrix 46 at this point may be considered as vehicle scores due to the corresponding scores being based on the vehicle charging metrics. Block 98 relates to identifying the individual vehicle scores performing below the historical average and using those vehicle scores to identify equivalent, current/last know scores, and historical average scores associated with the charging station metrics collected for the same charging station 16. The scores identified in Block 98 may be considered as station scores due to the corresponding scores being based on the station charging metrics.

Block 98 may be similar to Block 96 insofar as comparing the identified, current station scores to the historical average in order to identify whether the current station scores are tracking historical performance. Block 98 may include an additional threshold or hysteresis value aimed at identifying station scores deviating from the historical average by a greater amount (e.g., 10%) than the deviation permitted in Block 96 for the vehicle scores. This may be done to prioritize use of the vehicle scores over use of the station scores when the vehicle charging metrics are showing similar performance as the station charging metrics. The degree to which the vehicle scores derived from the vehicle charging metrics match or alignment with the station scores derived from station charging metrics provides the selection controller 42 with information helpful to assess whether information from the vehicles 14, which may be more trustworthy, is aligning with unknown or un-trusted information from third parties associated with the station controllers 36.

Block 102 relates to identifying if one or more of the current station scores exceeding the historical average for use in the SOH matrix 46 in place of the corresponding vehicle score. The replacement of one or more vehicle scores with a corresponding station score may be needed due to the vehicle score being unreliable or the sample of the vehicle charging metrics being too low. This intake of information from the charging stations 16, i.e., replacing vehicle score(s) with station score(s), may be beneficial in providing a third-party view of the performance. The ability to periodically rely upon the station scores may be beneficial in improving functionality of the user experience controller 44 in directing the vehicle 14 to a suitable charging station 16 in the event the more reliable vehicle charging metrics are experiencing disruption or otherwise unavailable. While the charging station metrics and station scores are described with respect to being generated with the station controllers 36, similar, outside information, may be generated by other third parties, such as by commercial entities configured to monitor the charging station 16.

Block 104 relates to visually coding the SOH matrix 46 after replacing any one or more of the vehicle scores with the corresponding station score. The visual coding may be an optional process where the selection controller 42 provides a visual frame of reference to the user experience controller 44 instead of just the numerical or alphanumerical representations of the scores. This may be helpful in enabling the user experience controller 44 to interface, such as through an infotainment system, the SOH matrix 46 to a vehicle operator in a more easily understood manner. The visual coding can be helpful in apprising operators less understanding of numerical references and/or the results attendant therewith to instead more easily rely upon a visual coding scheme. The visual coding scheme illustrated with respect to FIG. 2 is based on a pattern, however, a color-coded scheme may be a more universally understood reference. One non-limiting aspect of the present disclosure contemplates the visual coding being undertaken to reference the underlying score relative to a desired range.

The desired range may be based on a standard or predetermined range of normal values for each of the categories 50, 52, 54, 56, 58, 60, 62, 64, 66, 68 in the SOH matrix 46. The desired ranges, for example, may be based on industry standards or understood benchmarks such that the visual recording may be performed as a function of comparing the score in the matrix 46 to the desired standard, e.g., determining whether the corresponding scores are inoperably below, operably below, within, or exceeding the standard.

The desired ranges may also be based on relative scoring of the other charging stations 16 included in the SOH matrix 46. Such a relative coding may correspond with visual identifying how each of the charging station 16 compare with other charging stations 16 of the matrix 46, i.e., the scores are compared to each other instead of being compared to a standard. This relative scoring may be beneficial in enabling an operator to quickly identify how the charging stations 16 and the SOH matrix 46 compared to each other.

The desired ranges may be varied according to a number of variables, such as a time of day, the occurrence of an event, weather conditions, etc. The varying of the ranges may result in corresponding variance in the visual coding, e.g., a charging station 16 that may typically receive a green color coding may be temporarily or periodically changed to receive a yellow color coding during a particular time of day when the charging station is typically busier, when an event is likely to have more traffic, when weather charging capabilities are likely to vary from norms (e.g., higher and lower temperatures), when charging capabilities suffer from overuse, etc.

Block 106 relates to the selection controller 42 providing the visually coded SOH matrix 46 to the user experience controller 44 of the requesting vehicle 14. The user experience controller 44 may display the SOH matrix 46 directly to a vehicle occupant, such as through a screen included on the vehicle and/or an application execute on a mobile device in possession of the occupant. The occupant may then use the SOH matrix 46, optionally in conjunction with a touchscreen or other input feature, to select the desired one of the target charging stations 16 for the battery charging. The selection thereof may trigger the user experience controller 44 to instruct a navigation system to advise the occupant on traveling to the desired charging station 16. The user experience controller 44 may optionally include features for allowing the occupant to input preferences or other factors to normalize or otherwise scale the categories 50, 52, 54, 56, 58, 60, 62, 64, 66, 68 and/or the ranges fused for visual coding such that one or more categories may be prioritized or weighted differently than others, which may in turn adjust the overall rating 50 according to desires of the occupant.

The disclosure may be embodied in many different forms. Representative examples are shown in the various drawings and described herein in detail as non-limiting representations of the disclosed principles. To that end, elements and limitations described above, but not explicitly set forth in the appended claims, should not be incorporated into the claims, singly or collectively, by implication, inference, or otherwise. Moreover, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

“A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

Words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. Also as used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. For consistency and convenience, directional adjectives may be employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the disclosure, as defined by the claims. Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the drawing figures. Spatially relative terms may be intended to encompass different orientations of the device or system in use or operation in addition to the orientation depicted in the drawing figures.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed:

1. A system for smart selection of a charging station, the system comprising:
a metrics controller configured to:
receive vehicle charging metrics from a plurality of vehicles, the vehicles generating the vehicle charging metrics in response to engaging a plurality of charging stations for battery charging; and
receive station charging metrics from the plurality of charging stations, the charging stations generating the station charging metrics in response to engaging the vehicles for battery charging; and
a selection controller configured to transmit a charging recommendation in reply to a target vehicle of the vehicles issuing a charging request for battery charging, the charging recommendation identifying one or more target charging stations suitable for the battery charging, the target charging stations being selected from the charging stations suitable for the battery charging, the charging recommendation including a state of health (SOH) matrix reporting charging capabilities of the target charging stations according to the vehicle and station charging metrics associated therewith.

2. The system according to claim 1 further comprising charging controllers onboard the vehicles, the charging controllers being configured to collect the vehicle charging metrics in response to a charging system of the associated vehicle engaging one of the charging stations for battery charging.

3. The system according to claim 2 wherein the vehicle controllers and the charging stations collect the vehicle and station charging metrics to represent a charging mode, a charging voltage, a cost, a time of charging, a payment mode, a time duration, and a station ID for the associated charging station.

4. The system according to claim 3 wherein the SOH matrix includes plurality of categories, the plurality of categories including an overall ranking, a charging station ID, a charging efficiency, a time per regular charge, a time per fast charge, an additional charge for fast charge, a wait time, a wireless payment, and a deviation from route time, and a battery efficiency.

5. The system according to claim 4 wherein the SOH matrix includes a score within each of the categories to represent corresponding charging capabilities for each of the target charging stations.

6. The system according to claim 5 wherein each of the scores are coded according to one of a first coding, a second coding, a third coding, and a fourth coding.

7. The system according to claim 6 wherein the first coding represents the corresponding score being inoperably less than a range, the second coding represents the corresponding score being operably less than the range, the third coding represents the corresponding score being within the range, and the fourth coding represents the corresponding score being greater than the range.

8. The system according to claim 7 further comprising user experience controllers onboard the vehicles, the use experience controllers being configured to generate the charging request in response determining a need for battery charging.

9. The system according to claim 8 wherein the user experience controllers are configured to interface the SOH matrix with an operator of the associated vehicle.

10. The system according to claim 9 further comprising battery controllers onboard the vehicles, the battery controllers being configured to generate a battery report for a battery of the associated vehicle, the battery reports being generated in response to the battery controllers testing for health of the battery.

11. The system according to claim 10 wherein the battery controllers are configured to encrypt the battery reports before transmission to the selection controller.

12. The system according to claim 11 wherein the battery controllers perform testing on the associated battery to determine a battery SOH, an average reserve range, and a warmup prediction.

13. The system according to claim 10 wherein the selection controller is configured to generate the battery efficiency based at least in part on the health identified in the battery reports.

14. A method for smart selection of a charging station, the method comprising:
receiving vehicle charging metrics from a plurality of vehicles, the vehicles generating the vehicle charging metrics in response to charging systems of the vehicles engaging a plurality of charging stations for battery charging;
receiving station charging metrics from the plurality of charging stations, the charging stations generating the station charging metrics in response to engaging the vehicles for battery charging; and
transmitting a charging recommendation in reply to a vehicle of the vehicles issuing a charging request for battery charging, the charging recommendation identifying charging capabilities of one or more target charging stations of the charging stations according to the vehicle and station charging metrics associated therewith.

15. The method according to claim 14 further comprising generating the charging recommendation to include a state of health (SOH) matrix, the SOH matrix identifying the charging capabilities of the target charging stations.

16. The method according to claim 15 further comprising generating the SOH matrix to include a plurality of categories, the plurality of categories including an overall ranking, a charging station ID, a charging efficiency, a time per regular charge, a time per fast charge, an additional charge for fast charge, a wait time, a wireless payment, a deviation from route time, and a battery efficiency.

17. The method according to claim 16 further comprising visually coding a score included within each of the categories according to one of a first coding, a second coding, a third coding, and a fourth coding, the first coding representing the corresponding score being inoperably less than a range, the second coding representing the corresponding score being operably less than the range, the third coding representing the corresponding score being within the range, and the fourth coding representing the corresponding score being greater than the range.

18. The method according to claim 14 further comprising generating the vehicle charging metrics with charging controllers onboard the vehicles and generating the station charging metrics with station controls included on the charging stations.

19. The method according to claim 18 further comprising generating the charging recommendation with a selection controller offboard of the vehicles.

20. A system for smart selection of charging stations, the system comprising:
a plurality of charging controllers onboard a plurality of electric vehicles, the charging controllers being configured to collect vehicle charging metrics in response to a charging system of the associated vehicle engaging one of a plurality of charging stations for battery charging;
a plurality of station controllers included on the charging stations, the station controllers generating station charging metrics in response to engaging the vehicles for battery charging; and
a selection controller configured to transmit a charging recommendation in reply to a vehicle of the vehicles issuing a charging request for battery charging, the charging recommendation identifying one or more target charging stations of the charging stations, the charging recommendation including a state of health (SOH) matrix reporting charging capabilities of the target charging stations according to the vehicle and station charging metrics associated therewith.
